(19) United States
(12) Patent Application Publication
(10) Pub. No.: US 2024/0272321 A1
(43) Pub. Date: Aug. 15, 2024

(54) AUTONOMOUS SEISMIC NODE FOR THE SEABED

(71) Applicant: PXGEO UK Limited, Bristol (GB)

(72) Inventor: Jason Jurok, Calgary (CA)

(73) Assignee: PXGEO UK Limited, Bristol (GB)

(21) Appl. No.: 18/432,356

(22) Filed: Feb. 5, 2024

Related U.S. Application Data
(60) Provisional application No. 63/484,351, filed on Feb. 10, 2023.

(51) Int. Cl. G01V 1/18

(52) U.S. Cl. CPC G01V 1/188; G01V 2210/1427

(57) ABSTRACT

Ocean bottom seismic nodes formed of a non-metallic pressure housing that is substantially cuboid shaped, which may be formed of an injection molded plastic. The seismic node may have a detachable hydrophone housing that encloses a hydrophone and protects one or more external electrical connectors, which may have electrical connections that are substantially flat and flush with the hydrophone housing. A modular baseplate may be coupled to a bottom portion of the seismic node. A weight ballast may be positioned between the node housing and the modular baseplate. A mounting bracket may be coupled to an exterior portion of the seismic node without any direct fasteners.

### PRIORITY

This application claims priority to U.S. provisional patent application No. 63/484,351, filed on Feb. 10, 2023, the entire contents of which is incorporated herein by reference.

### BACKGROUND OF THE INVENTION

### Field of the Invention

This invention relates to marine seismic systems and more particularly relates to autonomous seismic nodes that may be deployed on the seabed.

### Description of the Related Art

Marine seismic data acquisition and processing generates a profile (image) of a geophysical structure under the seafloor. Reflection seismology is a method of geophysical exploration to determine the properties of the Earth's subsurface, which is especially helpful in determining an accurate location of oil and gas reservoirs or any targeted features. Marine reflection seismology is based on using a controlled source of energy (typically acoustic energy) that sends the energy through seawater and subsurface geologic formations. The transmitted acoustic energy propagates downwardly through the subsurface as acoustic waves, also referred to as seismic waves or signals. By measuring the time it takes for the reflections or refractions to come back to seismic receivers (also known as seismic data recorders or nodes), it is possible to evaluate the depth of features causing such reflections. These features may be associated with subterranean hydrocarbon deposits or other geological structures of interest.

In general, either ocean bottom cables (OBC) or ocean bottom nodes (OBN) are placed on the seabed. Marine seismic surveys need a fast and cost-effective system for deploying and recovering autonomous seismic receivers that are configured to operate underwater. One conventional method for the deployment of OBNs is to deploy a ROV in a body of water while also deploying a separate underwater node transfer device, such as a basket, that is configured to hold a plurality of seismic nodes and be lowered and raised from a surface vessel. At a certain subsea position, the ROV docks or mates with the node transfer device and transfers one or more nodes from the node transfer device to the ROV. The ROV then places the retrieved nodes at one or more positions on the seabed. Prior art patents and publications illustrating the use of an ROV or AUV to deploy or retrieve ocean bottom seismic nodes include at least the following: U.S. Pat. Nos. 6,975,560; 7,210,556; 7,324,406; 7,632,043; 8,310,899; 8,611,181; 9,415,848; 9,784,873; 9,873,496; 9,969,470; 10,099,760; 11,059,552, and 11,442,191, each of which is incorporated herein by reference. Still further, prior art patents also disclose the touch down monitoring of an ocean bottom seismic node by an autonomous underwater vehicle (AUV). See, e.g., U.S. Pat. No. 9,891,333. An ROV typically uses a TMS connected to a surface vessel for power and communications, which allows the ROV to travel up to 1300 meters from a TMS position. Distinct from an AUV is a remotely operated vehicle (ROV). In general, the structure and operation of marine ROVs are well known to those of ordinary skill. For example, Publication No. WO2014/090811, incorporated herein by reference, describes a ROV configured to deploy and retrieve autonomous seismic nodes to the seabed with a separate AUV configured to monitor and exchange data with the seismic nodes. Likewise, U.S. Pat. No. 8,075,226, incorporated herein by reference, describes a ROV configured to physically deploy autonomous seismic nodes from a carrier located on the ROV as well as a basket lowered by a surface vessel and to mechanically connect the ROV to the lowered basket to transfer nodes from the basket to the ROV carrier.

Autonomous ocean bottom nodes are independent seismometers, and in a typical application they are self-contained units comprising a housing, frame, skeleton, or shell that includes various internal components such as geophone and hydrophone sensors, a data recording unit, a reference clock for time synchronization, and a power source. The power sources are typically battery-powered, and in some instances the batteries are rechargeable. In operation, the nodes remain on the seafloor for an extended period of time. Once the data recorders are retrieved, the data is downloaded and batteries may be replaced or recharged in preparation of the next deployment. Various designs of ocean bottom autonomous nodes are well known in the art. Some of these devices and related methods are described in more detail in the following patents, incorporated herein by reference: U.S. Pat. Nos. 6,024,344; 7,310,287; 7,675,821; 7,646,670; 7,883,292; 8,427,900; 8,675,446; 9,523,780; and 10,514,473. Products available in the marketplace include Applicant's MANTA node, Sercel's GPR300 node, Geospace's Mariner node, Shearwater's Pearl node, and Magseis-Fairfield's Z100 node, each of which is incorporated herein by reference. Ocean bottom seismic nodes (OBNs) are typically designed to operate in either above or below 1000 m water depths. While nodes designed for deep water applications can be used in shallower water regions, the features required of a dedicated shallow water node may vary significantly.

The referenced shortcomings are not intended to be exhaustive, but rather are among many that tend to impair the effectiveness of previously known techniques in seafloor deployment systems; however, those mentioned here are sufficient to demonstrate that the methodologies appearing in the art have not been satisfactory and that a significant need exists for the systems, apparatuses, and techniques described and claimed in this disclosure.

A need exists for an improved autonomous seismic node design for automated node storage, handling, deployment, and recovery. A need exists for a node that provides increased operational parameters, increased seabed coupling, and more versatile deployment options. A need exists for a seismic node design that can be mass-produced in a cost-effective manner. A need exists for a node that can be used in multiple deployment configurations. A need exists for a seismic node design that enables large numbers of nodes to be operated in the field.

### SUMMARY OF THE INVENTION

Ocean bottom seismic nodes that comprise a non-metallic pressure housing that is substantially cuboid shaped. The seismic node may comprise a detachable hydrophone housing that encloses a hydrophone and protects one or more external electrical connectors, which may have electrical connections that are substantially flat and flush with the hydrophone housing. A modular baseplate may be coupled to a bottom portion of the seismic node. A weight ballast may be positioned between the node housing and the modular baseplate. A mounting bracket may be coupled to an exterior portion of the seismic node without any direct fasteners, such as by a clip-on fitting.

An ocean bottom seismic node, comprising a non-metallic pressurized node housing, wherein at least one seismic sensor, at least one data recording unit, and at least one clock are located within the node housing, and a detachable hydrophone housing coupled to the node housing, wherein at least one hydrophone is substantially contained within the hydrophone housing. The node housing may comprise an injected molded housing formed of polymeric material. The node housing may be formed substantially of a polymerized material. The detachable hydrophone housing may be coupled to a side face of the node housing. The at least one hydrophone is configured to be detached from the node housing when the detachable hydrophone housing is detached from the node housing. In one embodiment, a cross-sectional area of the seismic node is approximately a rectangle. In other embodiments the seismic node is substantially in the shape of a cuboid.

The seismic node may comprise a modular baseplate coupled to a bottom portion of the node housing, wherein the baseplate is approximately a rectangle. A ballast weight may be positioned between the node housing and the baseplate. The baseplate may comprise a plurality of mounting points for an accessory.

The node may comprise a plurality of external electrical connectors partially enclosed by the hydrophone housing. The node may comprise a plurality of external electrical connectors that are each configured to sit within a recess formed in an external face of the node pressure housing. The node may comprise a handling bracket coupled to a top portion of the seismic node, which may be coupled to the node housing by a clip-on fitting. The node may comprise a pressure relief valve, wherein the pressure relief valve is configured to fit within an integrated socket of the node housing.

Also disclosed is an ocean bottom seismic node, comprising a non-metallic pressurized node housing, wherein at least one seismic sensor, at least one data recording unit, and at least one clock are located within the node housing, and a removable baseplate coupled to a bottom portion of the node housing. The baseplate may be approximately in the shape of a rectangle. The baseplate may have a plurality of mounting points configured to attach an accessory. The seismic node may have a ballast weight positioned between the node housing and the baseplate.

Also disclosed is an on ocean bottom seismic node that comprises a non-metallic pressurized node housing, wherein at least one seismic sensor, at least one data recording unit, and at least one clock are located within the node housing. The seismic node may be substantially in the shape of a cuboid or have a cross-section that is rectangularly shaped. The node housing may be formed of an injected molded housing formed of polymeric material.

The seismic node may have a pressure relief valve, wherein the pressure relief valve is configured to fit within a valve seat formed in exterior face of the node housing. The seismic node may have a plurality of external electrical connectors that are each configured to sit within a recess formed in an external face of the node pressure housing, wherein the plurality of external connectors are secured to the node without the need for additional hardware. Each of the plurality of external electrical connectors may be pressure resistant, wherein each of the plurality of external electrical connectors is configured to be replaced from an exterior of the node housing. The seismic node may have a securing bracket coupled to a top portion of the seismic node, wherein the securing bracket is coupled to the node housing by a clip-on fitting, wherein a portion of the securing bracket is configured to couple with a cable attachment. The seismic node may have a digital printed circuit board (PCB) within the node housing and a plurality of polymeric supports within the node housing that is configured to isolate the PCB from the node housing.

The seismic node may comprise a removable hydrophone and a detachable hydrophone housing coupled to the node housing, wherein the detachable hydrophone housing is configured to protect the removable hydrophone, wherein the detachable hydrophone housing is acoustically transparent. The detachable housing may be configured to securely couple the detachable hydrophone to the node housing. The detachable hydrophone housing may be configured to securely couple a plurality of removable electrical connections to the node housing.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1A is a perspective view of one embodiment of an autonomous seismic node according to one embodiment of the present disclosure.

FIG. 1B is a perspective view of the seismic node from FIG. 1A, with the removable hydrophone assembly detached from the node housing.

FIG. 2A illustrates a top view of the seismic node from FIG. 1A.

FIG. 2B illustrates a bottom view of the seismic node from FIG. 1A.

FIG. 2C illustrates a front view of the seismic node from FIG. 1A.

FIG. 3 illustrates a mounting bracket of the seismic node from FIG. 1A.

FIG. 4 illustrates a removable hydrophone assembly of the seismic node from FIG. 1A.

FIG. 5A illustrates an external electrical data connector of the seismic node from FIG. 1A.

FIG. 5B illustrates an external electrical power connector of the seismic node from FIG. 1A.

FIG. 6 illustrates one embodiment of a modular base plate with a ballast that can be used with the seismic node from FIG. 1A.

FIG. 7 illustrates one embodiment of a pressure relief valve that can be used on the seismic node from FIG. 1A.

### DETAILED DESCRIPTION

Various features and advantageous details are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure. The following detailed description does not limit the invention.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures, or characteristics may be combined in any suitable manner in one or more embodiments.

### Overview

As detailed in the background section, ocean bottom seismic nodes are known in the art. Applicant offers an ocean bottom seismic node under the name of MANTA, which is more fully described in U.S. Pat. Nos. 9,523,780 (“the '780 Patent”) and 10,514,473 (“the '473 Patent”), incorporated herein by reference. The '780 Patent discloses a modular non-pressure housing that surrounds a node's pressure housing, to make the overall shape of the seismic node substantially square or cuboid in shape. The '473 Patent discloses a seabed coupling plate for a seismic node for enhanced seabed coupling between the seismic node and the seabed. The seismic node of the present application provides a novel solution to one or more of the industry's needs previously described herein and offers advantages over traditional seismic nodes. The disclosed seismic node may be utilized for shallow water applications or deep water applications.

The disclosed seismic node utilizes a polymeric material to form the node's pressure tolerant housing. Such a polymeric design is less expensive and easier to manufacture than conventional designs, and is also lighter weight and eliminates corrosion issues. The node housing may be formed of plastic by injection molding, which allows for injection molded connector assemblies and integrated sensor mounting positions within the housing. The disclosed seismic node utilizes an accessory mounting plate that couples directly to the pressure housing of the node and allows for easier handling of the node or specific coupling to a separate device. A removable hydrophone assembly may be coupled to the seismic node, which better protects the hydrophone than conventional seismic node designs and also better protects and secures any external electronic devices. A modular baseplate may be coupled to the seismic node, which can secure additional ballast weights or other devices between the baseplate and the seismic node housing, and may also allow for additional accessory mounting plates.

In one or more embodiments, the disclosed seismic node may be deployed to and retrieved from the seabed via any conventional method. Methods of deployment of such nodes from a marine vessel to the seabed are well known in the art. For example, Applicant's U.S. Pat. No. 9,784,873, incorporated herein by reference, discloses one method of coupling nodes to a deployment cable and then deploying that cable to the seabed. Other methods are also well known in the art. Alternatively, a node may be deployed to the seabed without the use of a cable, such as by dropping the node from a marine vessel or deploying the node with an ROV or AUV. The disclosed seismic node is not necessarily limited to the method of deployment to or retrieval from the seismic node and the seabed.

### Node Design

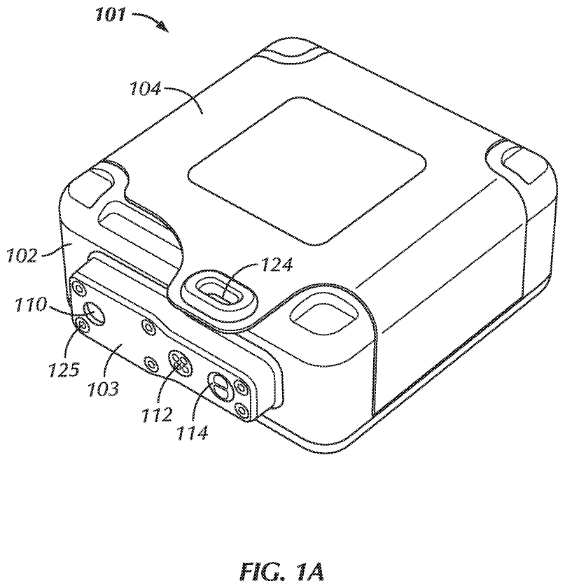

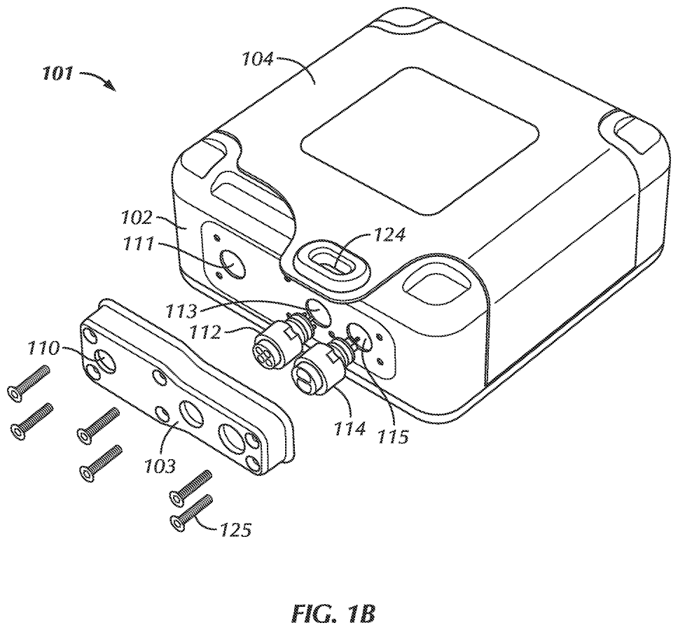

FIGS. 1A and 1B illustrate one embodiment of the disclosed seismic node. FIG. 1A illustrates a perspective view of autonomous seismic node 101, while FIG. 1B is a perspective view of the seismic node from FIG. 1A, with the removable hydrophone assembly detached from the node housing. In one embodiment, the disclosed seismic node contains the main elements found in conventional seismic nodes, such as those disclosed in the '780 Patent and the '473 Patent. The seismic node comprises one or more seismic sensors, a clock, a data recorder, and a power supply (such as rechargeable batteries). The electronic components may be located within a pressure resistant housing, which in one embodiment is formed of a polymeric material.

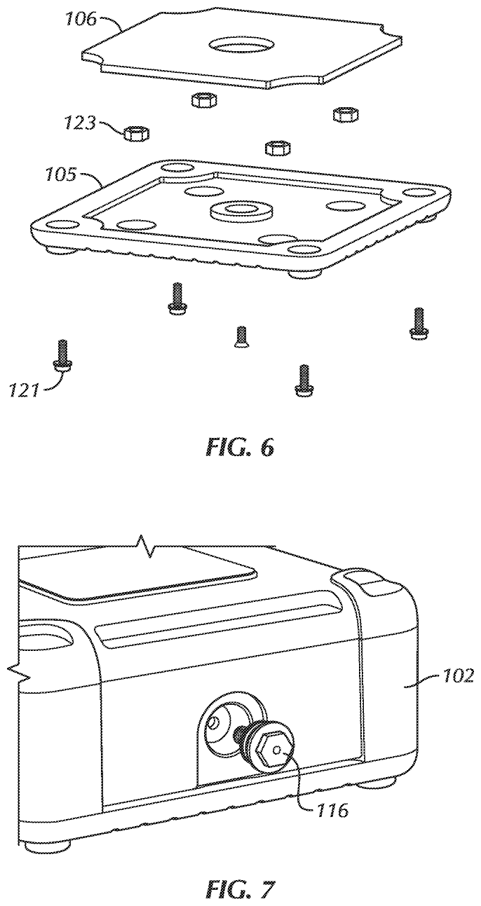

The internal components of the seismic node are generally not illustrated in the figures in this application. Seismic node 101 may include a body 102, such as a housing, frame, skeleton, or shell, which may be easily dissembled into various components. Additionally, seismic node 101 may include a power supply, such as one or more battery cells (not illustrated). In an embodiment, the battery cells may be lithium-ion battery cells or rechargeable battery packs for an extended endurance (such as 90 days) on the seabed, but one of ordinary skill will recognize that a variety of alternative battery cell types or configurations may also be used. Additionally, the seismic node may include pressure release valve (PRV) 116 (see FIG. 7) configured to release unwanted pressure from seismic node 101 at a pre-set level. The valve protects against fault conditions like water intrusion and outgassing from a battery package. Conventional pressure release valves are typically stand-alone items added to a node, which may include a valve seat and a spring-loaded poppet. In one embodiment, the valve seat of PRV 116 is formed directly into the material of node housing 102, which reduces the cost and complexity of the PRV assembly. Additionally, the seismic node may include one or more external electrical connectors 112, 114 configured to allow external access to information stored by internal electrical components, data communication, and power transfer. Additionally, the seismic node may include a removable hydrophone assembly 103 that is configured to removably detach from node body 102 and cover the electrical connectors and enclose a hydrophone. In other embodiments, the node does not have an external connector and data is transferred to and from the node wirelessly, such as via electromagnetic or optical links.

In an embodiment, the internal electrical components may include one or more hydrophones 110, one or more (preferably three) geophones or accelerometers, and a data recorder. In an embodiment, the data recorder may be a digital autonomous recorder configured to store digital data generated by the sensors or data receivers, such as hydrophone 110 and the one or more geophones or accelerometers. One of ordinary skill will recognize that more or fewer components may be included in the seismic node. For example, there are a variety of sensors that can be incorporated into the node including and not exclusively, inclinometers, rotation sensors, translation sensors, heading sensors, and magnetometers. Except for the hydrophone, these components are preferably contained within the node housing that is resistant to temperatures and pressures at the bottom of the ocean, as is well known in the art.

While node 101 is substantially rectangular or cuboid in shape, the node can be any variety of geometric configurations, including circular, square, rectangular, hexagonal, octagonal, cylindrical, and spherical, among other designs. In one embodiment, the node consists of a watertight, sealed case or pressure housing that contains all of the node's internal components. In another embodiment, the pressurizing node housing is partially and/or substantially surrounded by a non-pressurized node housing that provides the exterior shape, dimensions, and boundaries of the node, such as that disclosed in the '780 Patent. The node and/or non-pressurized housing may be square or substantially square shaped so as to be substantially a quadrilateral, as shown in FIG. 1A. In one embodiment the non-pressurized housing has a cross-sectional area that is non-circular and may be in the shape of a square or rectangle. For example, the node may have a first plurality of sides that are substantially parallel to each other and a second plurality of sides that are substantially parallel to each other. One of skill in the art will recognize that such a node is not a two-dimensional object, but includes a height, and in one embodiment may be considered a box, cube, elongated cube, or cuboid. In one embodiment, the node has six exterior faces or surfaces -four side faces, one bottom face, and one top face-and a plurality of corners that meet each of the faces. The corners and edges of the node may or may not be rounded, beveled, angled, or otherwise softened. While the node may be geometrically symmetrical about its central axis, symmetry is not a requirement. Further, the individual components of the node may not be symmetrical, but the combination of the various components (such as the pressurized housing and the non-pressurized housing) provide an overall mass and buoyancy symmetry to the node. In one embodiment, to ensure compatibility with a variety of vehicles while retaining optimal geophysical properties, the node may be a square body (length equals width) and has an aspect ratio (length and width to the height) between 2 and 2.5. For example, in one embodiment, the node may be approximately 300 mm×300 mm wide/deep with a height of approximately 100-150 mm. In one embodiment, the height of the node is less than or substantially less that (such as less than half) the width of the node. In other embodiments, the height of the node is approximately the same as the width of the node. The weight of the node may range from approximately 5-30 kilograms.

Node body or housing 102 provides many functions, such as protecting the node from shocks and rough treatment, coupling the node to the seabed for better readings (such as low distortion and/or high fidelity readings) and stability on the seabed, and assisting in the stackability, storing, alignment, and handling of the nodes. Node housing 102 may be made of a durable material such as rubber, plastic, or carbon fiber, and in one embodiment may be made of polyurethane or polyethylene. Further, the semi-rigid shape and properties of the housing provides mechanical shock damping to any internal components during retrieval and deployment operations. In one embodiment, the removable hydrophone housing 103 is configured to provide acoustical transparency to enclosed acoustic devices (e.g., it may have approximately the same acoustic impedance as water). This ensures that acoustic signals are not significantly attenuated, reflected, phase delayed, or otherwise distorted by the housing.

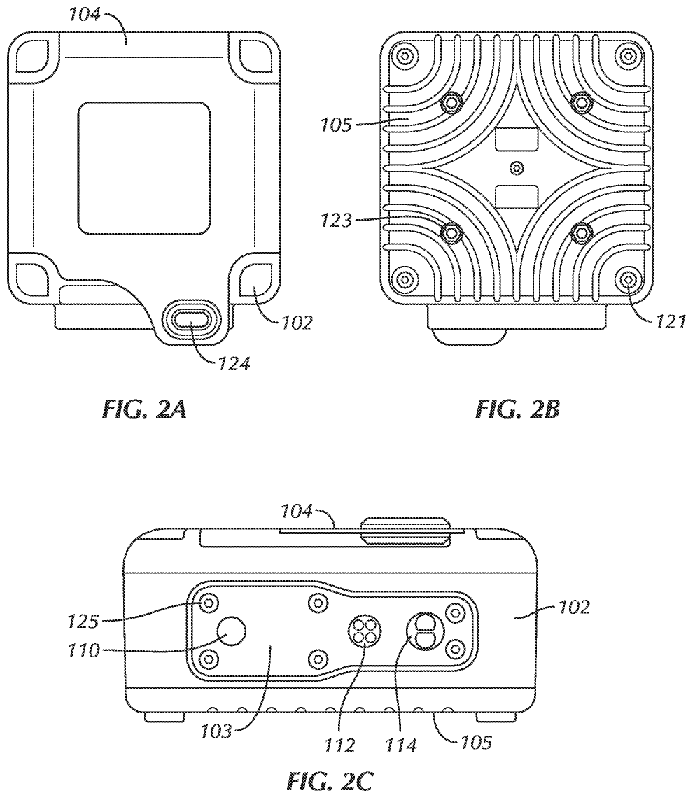

FIGS. 2A-2C illustrate a top view, a bottom view, and a front view, respectively, of the seismic node from FIG. 1A. In one embodiment, the node comprises a handling means to allow handling of the device in water and in air (such as on the back deck of a marine vessel). In one embodiment, it may be coupled to or be part of handling or mounting bracket 104. Handling means includes, but is not limited to, a protruding handle, ring or hook (such as handle 124), a rope or wire sling, a flat surface suitable for a suction device, pockets, recesses, cavities, and other devices known to those of ordinary skill in the art. The handling means may cooperate with a handling device, such as, but not limited to, a winch system, a remotely operating vehicle (ROV) manipulator, a suction device attached to an ROV, a remotely triggered pop-up buoy system, or even manual means by the use of a human operator. One of ordinary skill in the art would immediately recognize other means equally suited for this purpose. In this way, the device may be easily grasped, held, oriented/rotated, transported, and released in water and in air. In contrast, prior art nodes typically have limited to no dedicated mechanisms or configurations to hold and/or handle the nodes safely and effectively, not to mention that the heavy weights of such nodes prohibit large scale manual handling by a single operative.

A primary difference between the disclosed seismic node and prior art nodes is that in one embodiment node body 102 is a pressurized node body formed of a polymeric material, such as an injection molded, reinforced polymer. Using this polymeric material results in several advantages. First, the plastic material is less expensive than metal. Second, the plastic material does not result in corrosion issues as does metal and does not require any protective cover or surface treatment to prevent corrosion. Third, many of the internal features can be directly molded into the housing, thereby reducing the cost of having to fabricate, and then join, several other elements together. Of particular benefit to this approach is the integrated interface between the housing and the geophysical sensors, where a tight and rigid coupling produces higher data quality. Thus, the disclosed polymeric pressure housing provides significant economic benefits as well as technical benefits. In one embodiment, the internal support structure may comprise clip-on rubber pieces that slide into matching slots in the housing and secure the electronics within the use of any separate fasteners. The disclosed housing is rugged and helps absorb impact during handing, deployment, and recovery, and lessens the effects on sensitive electronics. Thus, the node housing itself, being formed of plastic, offers many of the same benefits as a separate protective bumper or housing around a pressurized metallic node housing offers, such as disclosed in the '780 Patent and '473 Patents.

In one embodiment, the polymeric material used for node body 102 should have certain properties in addition to its overall yield strength, such as low water absorption, resistance to brackish water and UV light, and an impact resistance to ensure the housing is not brittle and easily damaged during manual handling. In one embodiment, the polymeric material is formed of a Rigid Thermoplastic Polyurethane (RTPU) with at least 25% long glass fiber filler material. This composition allows for injection molding of the wall thicknesses required to support the hydrostatic pressure of the node on the seafloor without needing complex features that would otherwise make the node difficult to assemble. As demonstrated by the shape in FIG. 1A, the exterior of the disclosed seismic node must also be kept as hydrodynamically smooth as possible, which is aided by a polymeric design that is readily produced. Complex exterior features can induce noise in the seismic frequency spectrum as subsea currents pass over the node. The material selection must also be adequately rigid and easily machinable such that any required sealing interfaces can be implemented using traditional manufacturing techniques. In contrast to other prior art devices, the seismic node uses an internal support structure for the main recording module where the node clock resides.

FIGS. 5A and 5B illustrate an external electrical data connector and an external electrical power connector, respectively, of the seismic node from FIG. 1A. Seismic node 101 comprises one or more external electrical connections 112, 114. In one embodiment, one connector (such as connector 112) is configured for data communications and one connector (such as connector 114) is configured for power transfer. In other embodiments, the node does not have an external connector and data is transferred to and from the node wirelessly, such as via electromagnetic or optical links. The disclosed polymeric housing 102 allows for better transmission of wireless data (whether power or communications) to and from the node. Traditional nodes encounter various problems with direct electrical connections, including poor connections and manual handling to make electrical connections. To overcome these problems, the disclosed node includes flat contacts that are substantially flush with the body of the node. In one embodiment, the connections may be substantially similar to those flat connections disclosed in Applicant's U.S. Pat. No. 10,345,462 (“the '462 Patent”), incorporated herein by reference. These connections may be gold plated or other similar non-corrosive but conductive material. Such connections are illustrated in FIGS. 1A and 1B, and FIGS. 5A and 5B.

In one embodiment, electrical connectors 112, 114 are inserted into corresponding sized cavities in an exterior face of node body 102, such as cavities 113 and 115, respectively, as shown in FIG. 1B. In one embodiment, each connector comprises a removable module. Such removable connectors offer many benefits, including increased serviceability of the node, simplification of the node's assembly, and reduction of future failures for the connectors. The removable connectors reduces the overall number of sealing elements by a ratio of 1:n, wherein n is the number of electrical contacts in the connector. In one embodiment, rather than sealing each contact individually and placing them directly into the housing and having to make subsequent connections inside the node, several are grouped together into hermitically sealed and replaceable inserts. Such removable modules allows for pre-assembly manufacturing and testing of the electrical connections, thereby reducing the overall cost and time for node assembly. In one embodiment, a primary feature of these removable inserts is that the main body is injection molded in PEEK, a type of high strength and temperature tolerant polymer, with the electrical contacts in-situ. In one embodiment, the connectors are placed in cavities in an exterior portion of the body, but protrude out a certain distance, which is covered by removable hydrophone assembly 103. The removable hydrophone assembly is discussed in greater detail below, but in one embodiment protects and secures the electrical connectors into the node's housing.

An exterior side of the electrical connectors is substantially flat, and may be substantially flush with a face of the removable hydrophone assembly 103 when coupled to body 102. An interior side of the electrical connectors 112, 114 comprise pins or wires that couple with electronics inside of the seismic node. Connection and sealing techniques for the inside portion of the connectors may be similar to those described in the '462 Patent. On the face of the removable modules comprises flat electrical connections. The flat contact surfaces are much easier to keep clean and do not require any pressure protective cap, as is typical in the prior art. For external connections to the electrical connectors 112, 114, cables with spring loaded, ball nosed pins (such as those disclosed in the '462 Patent) are used to make contact with the flat portion of the connectors. Such a connection reduces the amount of surface wear when compared to a traditional pin and socket connection that uses a sliding/wiping contact point. When made, such a connection constitutes a flat electrical connection. As additional protection to these electrical connections, the node comprises devices to either interrupt electrical circuits (as in the case for data connections) or to simply short them together (as would be the case for the power connections). Such devices help eliminate any possible electrolytic corrosion between the contacts due to minute leakage currents sourced by the internal electronics. In one embodiment, the circuitry is implemented in a method that does not increase the overall power consumption or require the use of large devices capable of passing high current.

FIG. 4 illustrates a removable hydrophone assembly of the seismic node from FIG. 1A. In one embodiment, the seismic node includes hydrophone 110, which may be positioned in removable hydrophone assembly 103 and be positioned within hydrophone recess 111 of node body 102. Conventional seismic nodes use a traditional, off the shelf hydrophone sensor. These traditional sensors are delicate and easily damaged, and typically protrude out from a mounting base of the seismic node. The disclosed hydrophone is protected by being substantially enclosed within the removable hydrophone assembly. The removable hydrophone assembly attaches tangentially to a side of node body 102 by plurality of fasteners 125, such as screws. The removable hydrophone assembly also protects and secures any electrical connectors, as discussed above. In one embodiment, the removable hydrophone assembly may be shaped in a “key shaped” protrusion that fits into a corresponding download and charging module (not shown) on a surface vessel.

FIG. 6 illustrates one embodiment of a modular base plate with a ballast that can be used with the seismic node from FIG. 1A. In one embodiment, the seismic node includes a removable, modular baseplate that can be directly coupled to a bottom face of the seismic node. As shown in FIGS. 2B, 2C, and 6, the modular baseplate may be sized and shaped similar to the seismic node itself. In one embodiment, it may have a cross section that is approximately square or rectangular in shape. As shown in FIG. 6, it may be configured to hold and/or support a removable weight or ballast 106. Ballast 106 may be used to increase or decrease the weight of the seismic node (as needed based on operation conditions) with little to no change in the size of the node or the handling of the node. This modular design allows for adding supplementary accessories to improve the sea floor coupling, such as spikes, or increasing weight without removing the baseplate from the node. In one embodiment, the modular baseplate may have certain patterns, grooves, or spikes formed in the bottom face of the baseplate to better couple with the seabed, as disclosed in the '473 Patent. In one embodiment, a plurality of screws 121 couple the baseplate to node housing 102. In one embodiment, a plurality of mounting points 123 are located on the baseplate, which allows for one or more accessories to be coupled to the baseplate as needed.

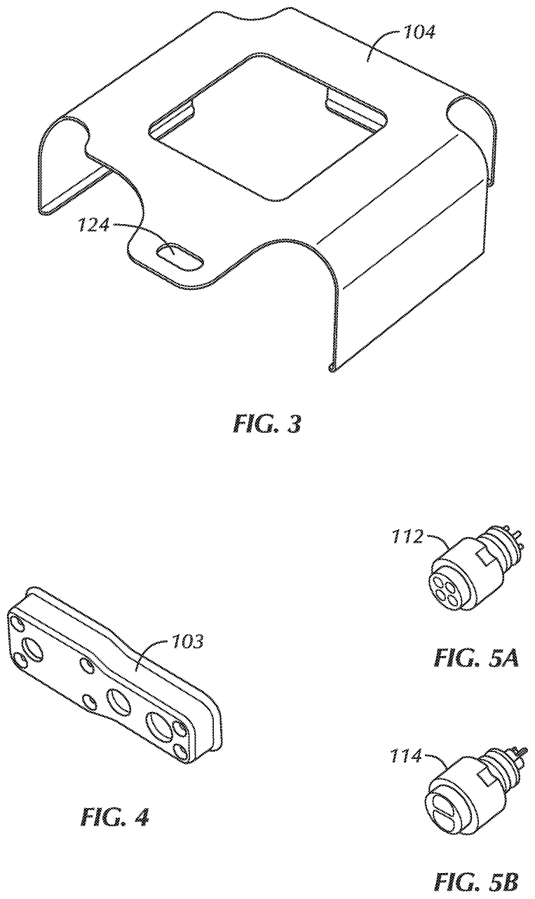

FIG. 3 illustrates a mounting bracket of the seismic node from FIG. 1A. The seismic node may include removable handling or mounting bracket 104, which itself has handle 124. In one embodiment, the handling bracket is a fastener free clip-on bracket that does not use separate fasteners (such as screws or bolts) to couple to the seismic node and/or node housing. When clipped on the node, bracket 104 sits flush with the rest of the housing to retain a smooth exterior surface. This reduces any current generated noise and presents the largest available area for a suction tool to grab the nodes. It also prevents the bracket from inadvertently slipping off the node during handling. Additionally, this modular bracket acts as an accessory that can be changed to suit different connection methods when deploying the seismic node via a rope or other deployment line (as opposed to a AUV deployment), which may include node locks or other rope/cable attachment points.

### Node Deployment

In one or more embodiments, the disclosed seismic node may be deployed to and retrieved from the seabed via any conventional method. The deployment and recovery methods of these nodes can vary significantly from one operating area to another. Methods of deployment of such nodes from a marine vessel to the seabed is well known in the art. For example, Applicant's U.S. Pat. No. 9,784,873, incorporated herein by reference, discloses one method of coupling nodes to a deployment cable and then deploying that cable to the seabed. Other methods are also well known in the art. Alternatively, a node may be deployed to the seabed without the use of a cable, such as by dropping the node from a marine surface vessel or deploying the node with an ROV or AUV. When deployed and recovered using a sub-sea vehicle, the physical size and the weight of the node must be kept low to increase the vehicles storage density. The disclosed seismic node is not necessarily limited to the method of deployment to or retrieval from the seismic node and the seabed.

In general, once the seismic nodes are deployed on the sea floor, a seismic survey can be performed. One or more marine vessels may contain a seismic energy source (not shown) and transmit acoustic signals to the sea floor for data acquisition by the seismic nodes 101. Embodiments of the system may be deployed in both coastal and offshore waters in various depths of water. For example, the system may be deployed in a few meters of water or in up to several thousand meters of water. As mentioned above, to perform a seismic survey that utilizes autonomous seismic nodes, those nodes must be deployed and retrieved from a vessel, typically a surface vessel. In one embodiment a node storage and service system is coupled to one or more deployment systems. The node storage and service system is configured to handle, store, and service the nodes before and after the deployment and retrieval operations performed by a node deployment system. Such a node storage and service system is described in more detail in U.S. Pat. No. 9,459,366, incorporated herein by reference. Such a node deployment system is described in more detail in U.S. Pat. No. 9,784,873, incorporated herein by reference.

Many other variations in the overall configuration of a node and the components within the node are possible within the scope of the invention. For example, the node may comprise more than two external electrical connectors, it may square or rectangular or circular in shape, and it may have wireless data communication capabilities. It may be formed of a metallic or non-metallic housing. The node housing may be substantially metallic or non-metallic, and may be formed substantially of a polymeric material or be formed of injection molding. It is emphasized that the foregoing embodiments are only examples of the very many different structural and material configurations that are possible within the scope of the present invention.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

What is claimed is:

1. An ocean bottom seismic node, comprising:
a non-metallic pressurized node housing, wherein at least one seismic sensor, at least one data recording unit, and at least one clock are located within the node housing; and
a detachable hydrophone housing coupled to the node housing, wherein at least one hydrophone is substantially contained within the detachable hydrophone housing.

2. The seismic node of claim 1, wherein the node housing comprises an injected molded housing formed of polymeric material.

3. The seismic node of claim 1, wherein the node housing is formed substantially of a polymerized material.

4. The seismic node of claim 1, wherein the detachable hydrophone housing is coupled to a side face of the node housing.

5. The seismic node of claim 1, wherein the at least one hydrophone is configured to be detached from the node housing when the detachable hydrophone housing is detached from the node housing.

6. The seismic node of claim 1, wherein a cross-sectional area of the seismic node is approximately a rectangle.

7. The seismic node of claim 1, wherein the seismic node is substantially in the shape of a cuboid.

8. The seismic node of claim 1, further comprising a baseplate coupled to a bottom portion of the node housing, wherein the baseplate is approximately a rectangle.

9. The seismic node of claim 8, further comprising ballast weight positioned between the node housing and the baseplate.

10. The seismic node of claim 8, wherein the baseplate comprises a plurality of mounting points configured to attach an accessory.

11. The seismic node of claim 1, further comprising a plurality of external electrical connectors partially enclosed by the detachable hydrophone housing.

12. The seismic node of claim 1, further comprising a plurality of external electrical connectors that are each configured to sit within a recess formed in an external face of the node pressure housing.

13. The seismic node of claim 1, further comprising a handling bracket coupled to a top portion of the seismic node.

14. The seismic node of claim 13, wherein the handling bracket is coupled to the node housing by a clip-on fitting.

15. The seismic node of claim 1, further comprising a pressure relief valve, wherein the pressure relief valve is configured to fit within an integrated socket of the node housing.

16. An ocean bottom seismic node, comprising:
a non-metallic pressurized node housing, wherein at least one seismic sensor, at least one data recording unit, and at least one clock are located within the node housing; and
a removable baseplate coupled to a bottom portion of the node housing, wherein the baseplate is approximately a rectangle, wherein the baseplate comprises a plurality of mounting points configured to attach an accessory.

17. The seismic node of claim 16, further comprising ballast weight positioned between the node housing and the baseplate.

18. An ocean bottom seismic node, comprising:
a non-metallic pressurized node housing, wherein at least one seismic sensor, at least one data recording unit, and at least one clock are located within the node housing,
wherein the seismic node is substantially in the shape of a cuboid.

19. The seismic node of claim 18, further comprising a pressure relief valve, wherein the pressure relief valve is configured to fit within a valve seat formed in exterior face of the node housing.

20. The seismic node of claim 18, further comprising a plurality of external electrical connectors that are each configured to sit within a recess formed in an external face of the node pressure housing, wherein the plurality of external connectors are secured to the node without the need for additional hardware.

21. The seismic node of claim 20, wherein each of the plurality of external electrical connectors is pressure resistant, wherein each of the plurality of external electrical connectors is configured to be replaced from an exterior of the node housing.

22. The seismic node of claim 18, further comprising a securing bracket coupled to a top portion of the seismic node, wherein the securing bracket is coupled to the node housing by a clip-on fitting, wherein a portion of the securing bracket is configured to couple with a cable attachment.

23. The seismic node of claim 18, further comprising a removable hydrophone and a detachable hydrophone housing coupled to the node housing, wherein the detachable hydrophone housing is configured to protect the removable hydrophone, wherein the detachable hydrophone housing is acoustically transparent.

24. The seismic node of claim 23, wherein the detachable housing is configured to securely couple the detachable hydrophone to the node housing.

25. The seismic node of claim 23, wherein the detachable hydrophone housing is configured to securely couple a plurality of removable electrical connections to the node housing.

26. The seismic node of claim 18, further comprising
a digital printed circuit board (PCB) within the node housing; and
a plurality of polymeric supports within the node housing that is configured to isolate the PCB from the node housing.

27. The seismic node of claim 18, wherein the node housing comprises an injected molded housing formed of polymeric material.
